(19) United States
(12) Patent Application Publication
(10) Pub. No.: US 2017/0159619 A1
(43) Pub. Date: Jun. 8, 2017

(54) ENGINE SYSTEM COMPRISING A BURNT GAS RECIRCULATION CIRCUIT

(71) Applicant: Valeo Systemes de Controle Moteur, Cergy Saint Christophe (FR)

(72) Inventors: Pierre-Julian Angelot, Sartrouville (FR); Sylvain Decoster, Fontenay Le Fleury (FR); Youssef Ismail, Paris (FR)

(73) Assignee: Valeo Systemes de Controle Moteur, Cergy Saint Christophe (FR)

(21) Appl. No.: 15/321,265

(22) PCT Filed: Jun. 26, 2015
(86) PCT No.: PCT/FR2015/051736

§ 371 Date: Dec. 22, 2016

(30) Foreign Application Priority Data
Jun. 26, 2014 (FR) 1455947

(51) Int. Cl. F02M 26/34; F02B 39/10; F01N 5/04; F02B 37/10; F02M 26/05; F02M 26/22

(52) U.S. Cl. CPC F02M 26/34; F02M 26/05; F02M 26/22; F01N 5/04; F02B 37/10; F02B 39/10

(57) ABSTRACT

The invention relates to an engine system (10) comprising a circuit (21) for the recirculation of burnt gases from a heat engine (17) equipped with a turbocharger (13, 19), in which the recirculation circuit (21) comprises am energy recovery turbine (30) receiving high-pressure exhaust gases upstream of the turbocharger.

The present invention relates to heat machines, and more particularly internal combustion engines with a burnt gas recirculation circuit and turbocharger.

Many diesel engines equipping motor vehicles are equipped with turbochargers to increase the pressure of the intake gases. These turbochargers include an air compressor driven by a turbine driven by the pressure from the exhaust gases.

The invention more particularly examines engines with high-pressure exhaust gas recirculation, in which a fraction of the exhaust gases taken from upstream of the turbine of the turbocharger is mixed with the intake gases, after crossing through an EGR valve creating a pressure drop. Such recirculation in particular makes it possible to reduce the nitrogen oxide (NOx) content level of the exhaust gases of the engines. The aforementioned pressure drop causes an energy loss that is not recovered in the current engines.

The invention seeks to further improve the performance of turbocharger and burnt gas recirculation engines, and achieves this aim owing to the fact that the recirculation circuit includes an energy recovery turbine receiving the high-pressure exhaust gases upstream of the turbocharger.

Owing to the invention, part of the energy lost in the current engines can be recovered in order to reduce fuel consumption.

The recirculation circuit preferably includes an intercooler downstream of the turbine. The engine system may include a valve downstream of the energy recovery turbine, this valve preferably being of the on/off type.

The energy recovery turbine can be mechanically coupled to elements of the engine system to retrieve mechanical energy or be coupled to an electrical generator.

The energy delivered by this generator can for example be used at least in part to power an electric assistance motor for the turbocharger.

Alternatively, the energy delivered by the generator is used at least in part to power an electric assistance motor for the crankshaft of the heat engine.

The energy recovery turbine can also be mechanically coupled to the crankshaft of the heat engine or the turbocharger.

The energy recovery turbine may also alternatively be coupled to a compressor of the air intake circuit, other than that of the turbocharger.

The heat engine is preferably a diesel engine.

The invention also relates to a vehicle, in particular an automobile, equipped with an engine system according to the invention,

The invention may be better understood upon reading the following detailed description of non-limiting example embodiments thereof, and upon examining the appended drawing, in which:

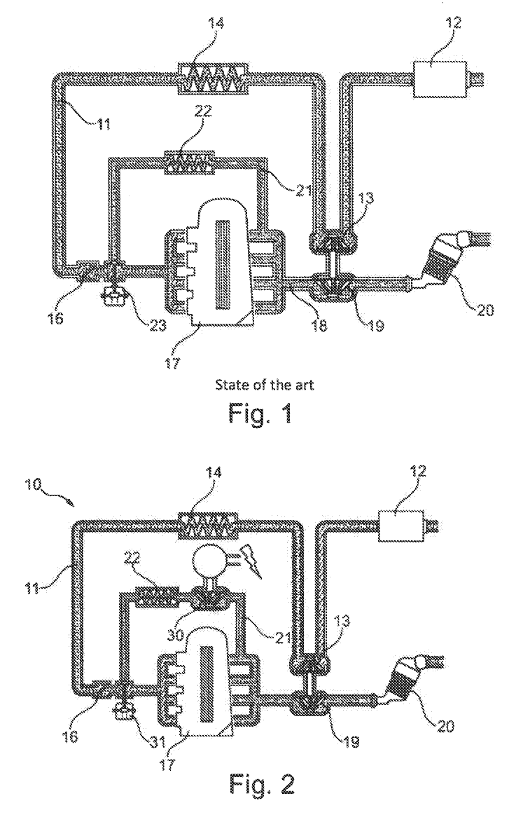

FIG. 1 shows an engine architecture according to the state of the art,

FIG. 2 illustrates the introduction of an energy recovery turbine into the high-pressure recirculation circuit according to the invention, and

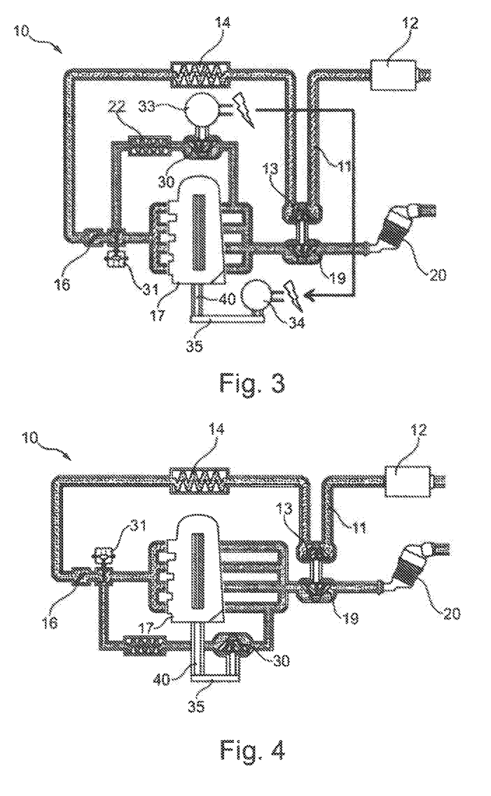

FIGS. 3 to 7 are different examples of engine systems according to the invention, making it possible to use the energy recovered by the turbine.

The known architecture shown in FIG. 1, also called engine system, includes, in a known manner, an internal combustion heat engine 17 connected to an air intake circuit 11 in the engine, including an air filter 12 at the inlet, a turbocharger compressor 13 to compress the air intended for the engine, and an intercooler 14 downstream of the compressor 13 to cool the charge air. A flow rate adjusting device 16, such as a butterfly valve, makes it possible to control the air flow rate taken into the internal combustion engine 17. The latter is connected to an exhaust circuit 18 that includes a turbocharger turbine 19, driven by the exhaust gases, coupled to the supercharger 13 to rotate it.

The exhaust circuit 18 also includes a burnt gas treatment device 20 downstream of the turbine 19.

A recirculation circuit 21, provided with an intercooler 22, captures part of the burnt gases, upstream of the turbine 19, to reinject them with a controlled flow rate into the engine 17, via a valve 23, called EGR valve, that creates a sufficient pressure loss.

FIG. 2 shows an architecture 10 according to the invention. It copies elements of the known architecture shown in FIG. 1, which will not be described in detail, and the same numerical references have been used to designate elements that have an identical or similar function.

According to the invention, an energy recovery turbine 30 is placed in the burnt gas recirculation circuit 21, this turbine achieving substantially the same expansion rate as the valve 23 of the known architecture, thus creating a pressure drop making it possible to bring the gases to be reinjected to a pressure compatible with this reinjection. Thus, the valve 23 of the state of the art can be replaced by a valve 23 introducing a lower pressure loss, and which, for example, works by all or none operation.

The rotation of the turbine 30 is used to assist the working of the vehicle, for example by relieving the alternator in electricity production and/or by providing mechanical assistance to the engine or to elements of the engine architecture, such as the turbocharger.

In the example of FIG. 3, the turbine 30 is thus coupled to an electric generator 33. An electric motor 34 is coupled to the crankshaft 40 of the engine 17, to provide it with mechanical assistance. This motor 34 is at least partially powered by the electricity produced by the generator 33.

In the example of FIG. 4, turbine 30 is mechanically coupled to the crankshaft 40 to assist it in its rotation. This coupling can be done by a transmission 35 that may be of any type, for example with belt(s) and/or gears.

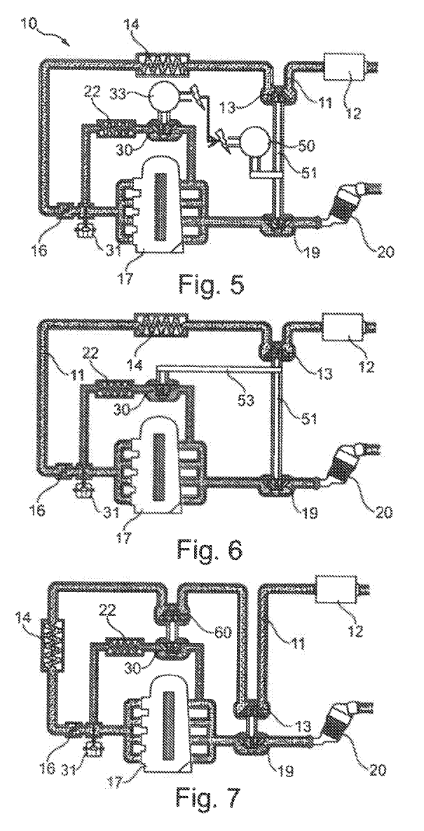

In the example of FIG. 5, the turbine 30 drives a power generator 33, as in the example of FIG. 3. A motor 50 is at least partially powered by the energy produced by this generator 33. The motor 50 produces mechanical assistance for a shaft 51 of the turbocharger, thereby contributing to driving the compressor 13 of the turbocharger, on the air supply side.

In the example of FIG. 6, the energy recovery turbine 30 is mechanically coupled via a transmission 53 to the shaft 51 of the turbocharger, thereby providing mechanical assistance for the driving of the compressor 13.

In the example of FIG. 7, the turbine 30 is coupled to a compressor 60 arranged downstream of the compressor 13 of the turbocharger in the air supply circuit 11, and the compressor 60 contributes to increasing the pressure of the charge air of the engine, which may make it possible to relieve the compressor 13. This second compressor 16 is for example placed upstream of the intercooler 14.

One advantage of the power recovery in the burnt gas recirculation circuit is the absence of back pressure impact on the engine, and this energy recovery may be done without increased fuel consumption or pollutants.

In an application to a motor vehicle, a simulation shows that the maximum energy recovery zone is situated on the engine operating points where the vehicle is working in stabilized operation at a relatively high speed, exceeding 80 km/h, which allows continuous recovery of the energy where hybrid systems are inoperative. Furthermore, extracting the entropy of the recirculation gases makes it possible to undersize the components of the recirculation circuit downstream, which are subject to a lower temperature. if applicable, depending on the calibration of the engine, the valve 31 may be eliminated.

Simulations on a vehicle with a speed stabilized at 110 km/h, with an engine rating of 2500 revolutions per minute and a burnt gas pressure of 9 bars, show that it is possible to extract approximately 7 isentropic kW, and this power may, for this engine operating point, allow the following energy gains:
2.1% consumption gain when the turbine 33 is used to drive an electric generator, relative to electricity production done using the alternator,
1.5% in case of electric assistance of the engine as illustrated in FIGS. 3,
2.1% in case of mechanical assistance of the engine as illustrated in FIG. 4,
2.6% in case of electrical assistance of the turbocharger, as illustrated in FIGS. 5, and
1.1% in case of mechanical assistance of the turbocharger, as illustrated in FIG. 6.

Of course, the invention is not limited to the illustrated examples.

The illustrated architectures may for example be further modified, for example by eliminating the valve 31 from these examples,

The invention applies to an engine for a land, naval or air vehicle, as well as motors for power generators and any other applications using a heat engine with a turbocharger and high-pressure burnt gas recirculation.

The expression “including a” must be understood as being synonymous with “comprising at least one”.

1. An engine system comprising:
a recirculation circuit for the recirculation of burnt gases coming from a heat engine equipped with a turbocharger,
wherein the recirculation circuit includes an energy recovery turbine receiving the high-pressure exhaust gases upstream of the turbocharger and a valve downstream of the turbine.

2. The engine system according to claim 1, the recirculation circuit including an intercooler downstream of the turbine.

3. The engine system according to claim 1, the valve being of the on/off type.

4. The engine system according to claim 1, the turbine being mechanically coupled to an electrical generator.

5. The engine system according to claim 4, the energy delivered by the generator being used at least in part to power an electric assistance motor for the turbocharger.

6. The engine system according to claim 4, the energy delivered by the generator being used at least in part to power an electric assistance motor for the crankshaft of the heat engine.

7. The engine system according to claim 1, the energy recovery turbine being mechanically coupled to the crankshaft of the heat engine.

8. The engine system according to claim 1, the energy recovery turbine being mechanically coupled to the turbocharger.

9. The engine system according to claim 1, the energy recovery turbine being coupled to a compressor of the air intake circuit.

10. The engine system according to claim 1, the heat engine being a diesel engine,

11. An automobile vehicle, equipped with an engine system as defined in claim 1.
